(19) United States
(12) Patent Application Publication
(10) Pub. No.: US 2024/0143641 A1
(43) Pub. Date: May 2, 2024

(54) CLASSIFYING DATA ATTRIBUTES BASED ON MACHINE LEARNING

(71) Applicant: SAP SE, Walldorf (DE)

(72) Inventors: Lev Sigal, Karmiel (IL); Anna Fishbein, Hadera (IL); Anton Ioffe, Netanya (IL); Iryna Butselan, Netanya (IL)

(21) Appl. No.: 18/049,958

(22) Filed: Oct. 26, 2022

(51) Int. Cl. G06F 16/35; G06N 5/02

(52) U.S. Cl. CPC G06F 16/35; G06N 5/022

(57) ABSTRACT

Some embodiments provide a non-transitory machine-readable medium that stores a program. The program may receive a plurality of string data. The program may determine an embedding for each string data in the plurality of string data. The program may cluster the embeddings into groups of embeddings. The program may determine a plurality of labels for the plurality of string data based on the groups of embeddings. The program may use the plurality of labels and the plurality of string data to train a classifier model. The program may provide a particular string data as an input to the trained classifier model, wherein the classifier model is configured to determine, based on the particular string data, a classification for the particular string data.

### BACKGROUND

Machine learning involves the use of data and algorithms to learn to perform a defined set of tasks accurately. Typically, a machine learning model can be defined using a number of approaches and then trained, using training data, to perform the defined set of tasks. Once trained, a trained machine learning model may be used (e.g., performing inference) by providing it with some unknown input data and having trained machine learning model perform the defined set of tasks on the input data. Machine learning may be used in many different applications (e.g., image classification, computer vision, natural language processing, speech recognition, writing recognition, etc.).

### SUMMARY

In some embodiments, the techniques described herein relate to a non-transitory machine-readable medium storing a program executable by at least one processing unit of a device, the program including sets of instructions for: receiving a plurality of string data; determining an embedding for each string data in the plurality of string data; clustering the embeddings into groups of embeddings; determining a plurality of labels for the plurality of string data based on the groups of embeddings; using the plurality of labels and the plurality of string data to train a classifier model; and providing a particular string data as an input to the trained classifier model, wherein the classifier model is configured to determine, based on the particular string data, a classification for the particular string data.

In some embodiments, the techniques described herein relate to a non-transitory machine-readable medium, wherein the embedding for each string data in the plurality of string data is a vectorized representation of the string data.

In some embodiments, the techniques described herein relate to a non-transitory machine-readable medium, wherein clustering the embeddings into the groups of embeddings includes using a k-means clustering algorithm to cluster the embeddings into the group of embeddings.

In some embodiments, the techniques described herein relate to a non-transitory machine-readable medium, wherein the program further includes a set of instructions for determining a number of the groups of embeddings into which the embeddings are clustered.

In some embodiments, the techniques described herein relate to a non-transitory machine-readable medium, wherein determining the number of the groups of embeddings includes determining the number of the groups of embeddings based on a silhouette analysis technique.

In some embodiments, the techniques described herein relate to a non-transitory machine-readable medium, wherein determining the number of the groups of embeddings includes determining the number of the groups of embeddings based on an elbow method.

In some embodiments, the techniques described herein relate to a non-transitory machine-readable medium, wherein the plurality of labels includes a plurality of cluster identifiers, each cluster identifier in the plurality of cluster identifiers for identifying a group of embeddings in the groups of embeddings.

In some embodiments, the techniques described herein relate to a method including: receiving a plurality of string data; determining an embedding for each string data in the plurality of string data; clustering the embeddings into groups of embeddings; determining a plurality of labels for the plurality of string data based on the groups of embeddings; using the plurality of labels and the plurality of string data to train a classifier model; and providing a particular string data as an input to the trained classifier model, wherein the classifier model is configured to determine, based on the particular string data, a classification for the particular string data.

In some embodiments, the techniques described herein relate to a method, wherein the embedding for each string data in the plurality of string data is a vectorized representation of the string data.

In some embodiments, the techniques described herein relate to a method, wherein clustering the embeddings into the groups of embeddings includes using a k-means clustering algorithm to cluster the embeddings into the group of embeddings.

In some embodiments, the techniques described herein relate to a method further including determining a number of the groups of embeddings into which the embeddings are clustered.

In some embodiments, the techniques described herein relate to a method, wherein determining the number of the groups of embeddings includes determining the number of the groups of embeddings based on a silhouette analysis technique.

In some embodiments, the techniques described herein relate to a method, wherein determining the number of the groups of embeddings includes determining the number of the groups of embeddings based on an elbow method.

In some embodiments, the techniques described herein relate to a method, wherein the plurality of labels includes a plurality of cluster identifiers, each cluster identifier in the plurality of cluster identifiers for identifying a group of embeddings in the groups of embeddings.

In some embodiments, the techniques described herein relate to a system including: a set of processing units; and a non-transitory machine-readable medium storing instructions that when executed by at least one processing unit in the set of processing units cause the at least one processing unit to: receive a plurality of string data; determine an embedding for each string data in the plurality of string data; cluster the embeddings into groups of embeddings; determine a plurality of labels for the plurality of string data based on the groups of embeddings; use the plurality of labels and the plurality of string data to train a classifier model; and provide a particular string data as an input to the trained classifier model, wherein the classifier model is configured to determine, based on the particular string data, a classification for the particular string data.

In some embodiments, the techniques described herein relate to a system, wherein the embedding for each string data in the plurality of string data is a vectorized representation of the string data.

In some embodiments, the techniques described herein relate to a system, wherein clustering the embeddings into the groups of embeddings includes using a k-means clustering algorithm to cluster the embeddings into the group of embeddings.

In some embodiments, the techniques described herein relate to a system, wherein the instructions further cause the at least one processing unit to determine a number of the groups of embeddings into which the embeddings are clustered.

In some embodiments, the techniques described herein relate to a system, wherein determining the number of the groups of embeddings includes determining the number of the groups of embeddings based on a silhouette analysis technique.

In some embodiments, the techniques described herein relate to a system, wherein determining the number of the groups of embeddings includes determining the number of the groups of embeddings based on an elbow method.

The following detailed description and accompanying drawings provide a better understanding of the nature and advantages of various embodiments of the present disclosure.

### BRIEF DESCRIPTION OF THE DRAWINGS

FIG. 1 illustrates a computing system for classifying data attributes based on machine learning according to some embodiments.

FIG. 2 illustrates an example of retrieving expense data and generating embeddings according to some embodiments.

FIG. 3 illustrates an example of determining clusters of the embeddings illustrated in FIG. 2 according to some embodiments.

FIG. 4 illustrates an example of labeling the expense data illustrated in FIG. 2 according to some embodiments.

FIG. 5 illustrates an example of training a classifier model according to some embodiments.

FIG. 6 illustrates an example of using the classifier model illustrated in FIG. 5 according to some embodiments.

FIG. 7 illustrates a process for classifying data attributes based on machine learning according to some embodiments.

FIG. 8 illustrates an exemplary computer system, in which various embodiments may be implemented.

FIG. 9 illustrates an exemplary system, in which various embodiments may be implemented.

### DETAILED DESCRIPTION

In the following description, for purposes of explanation, numerous examples and specific details are set forth in order to provide a thorough understanding of the present disclosure. It will be evident, however, to one skilled in the art that various embodiment of the present disclosure as defined by the claims may include some or all of the features in these examples alone or in combination with other features described below, and may further include modifications and equivalents of the features and concepts described herein.

Described herein are techniques for classifying data attributes based on machine learning. In some embodiments, a computing system is configured to manage machine learning models that may be used to classify data attributes. For example, the computing system can train a classifier model by generating training data for the classifier model. The computing system may generate the training data by retrieving unique values for a particular data attribute. The unique values can be strings, for example. Next, the computing system generates an embedding for each unique value for the particular data attribute. Based on the embeddings, the computing system uses a clustering algorithm to group the embeddings into groups of embeddings. Based on the groups of embeddings, the computing system labels each of the unique values for the particular attribute. For instance, each group of embeddings may be identified using a cluster identifier. In such an example, the computing system uses the cluster identifier of the group to which the embedding of a unique value belongs as the label for the unique value. Then, the computing system uses the labeled unique values for the particular attribute to train the classifier model to predict cluster identifiers based on values for the particular attribute. That is, for a given value of the particular attribute, the classifier model is trained to determine a cluster identifier for with the given value of the particular attribute.

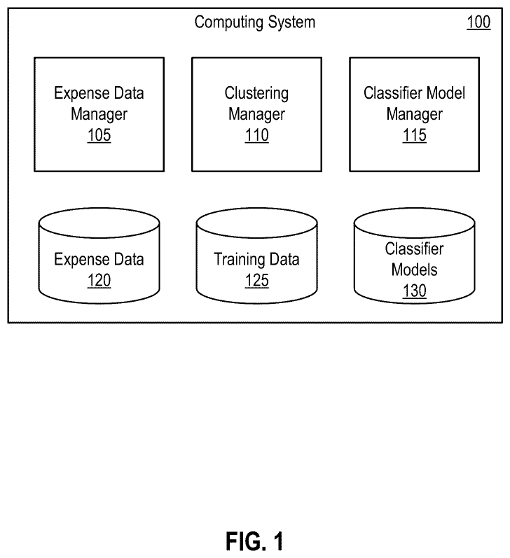

FIG. 1 illustrates a computing system 100 for classifying data attributes based on machine learning according to some embodiments. As shown, computing system 100 includes expense data manager 105, clustering manager 110, classifier model manager 115, expense data storage 120, training data storage 125, and classifier models storage 130. Expense data storage 120 is configured to store expense data. Examples of expense data include expense reports. An expense report can include one or more line items. Each line item may include a set of attributes, such as a transaction date on which a good or service was purchased, a type of the good or service, a description of a vendor that provided the good or service purchased, an amount of the good or service, a type of payment used to pay for the good or service, etc. Training data storage 125 stores sets of training data for training classifier models. Classifier models storage 130 is configured to store classifier models and trained classifier models. Examples of classifier models include a random forest classifier, a perceptron classifier, a Naive Bayes classifier, a logistic regression classifier, a k-nearest neighbors classifier, etc.

In some embodiments, storages 120-130 are implemented in a single physical storage while, in other embodiments, storages 120-130 may be implemented across several physical storages. While FIG. 1 shows expense data storage 120, training data storage 125, and classifiers models storage 130 as part of computing system 100, one of ordinary skill in the art will appreciate that expense data storage 120, training data storage 125, and/or classifier models storage 130 may be external to computing system 100 in some embodiments.

Expense data manager 105 is responsible for managing expense data. For example, at defined intervals, expense data manager 105 can retrieve expense data from expense data storage 120 for processing. In some embodiments, expense data manager 105 retrieves expense data from expense data storage 120 in response to receiving a request (e.g., from a user of computing system 100, from a user of a client device interacting with computing system 100, etc.). In some cases, the expense data that expense data manager 105 retrieves from expense data storage 120 are unique values of a particular attribute in the expense data. Expense data manager 105 can perform different types of processing for different types of unique values. For instance, if the unique values of a particular attribute in the expense data are strings (e.g., words, phrases, a sentence, etc.), expense data manager 105 may generate an embedding of each of the unique values based on a string embedding space generated from a corpus of strings. In some embodiments, a string embedding space maps strings in the corpus to numeric representations (e.g., vectors). Thus, an embedding of a string is a vectorized representation of the string (e.g., an array of numerical values, such as floating point numbers, for example). After expense data manager 105 generates embeddings for each of the unique values of the particular attribute, expense data manager 105 sends the embeddings to clustering manager 110 for further processing.

Clustering manager 110 is configured to manage the clustering of data. For example, clustering manager 110 can receive embeddings of unique strings from expense data manager 105. In response, clustering manager 110 groups the embeddings into groups of embeddings. In some embodiments, clustering manager 110 uses a clustering algorithm to group the embeddings. Examples of clustering algorithms include a k-means clustering algorithm, a density-based spatial clustering of applications with noise (DBSCAN) clustering algorithm, a mean-shift clustering algorithm, an ordering points to identify the clustering structure (OPTICS) clustering algorithm, etc. After grouping the embeddings into groups, clustering manager 110 assigns labels to the original string values of the particular attribute based on the groups of embeddings. For instance, each group of embeddings may have a group identifier (ID). In some of those instances, clustering manager 110 determines the group ID to which the embedding of a string value belongs and assigns the group ID to the string value. Then, clustering manager 110 stores the strings and their associated groups IDs as a set of training data in training data storage 125.

Classifier model manager 115 handles the training of classifier models. For example, to train a classifier model to determine classifications for values of an attribute, classifier model manager 115 retrieves the classifier model from classifier models storage 130. Next, classifier model manager 115 retrieves from training data storage 125 a set of training data that includes values of the attribute and labels associated with the values. Then, classifier model manager 115 uses the set of training data to train the classifier model (e.g., providing the set of training data as inputs to the classifier model, comparing the classifications predicted by the classifier model with the corresponding labels, adjusting the weights of the classifier model based on the comparisons, etc.). After classifier model manager 115 finishes training the classifier model, classifier model manager 115 stores the trained classifier model in classifier models storage 130.

In addition, classifier model manager 115 handles using classifier models for inference. For instance, classifier model manager 115 can receive a request (e.g., from computing system 100, an application or service operating on computing system 100, an application or service operating on another computing system, a client device interacting with computing system 100, etc.) to determine a classification for a value of an attribute in expense data. In response to such a request, classifier model manager 115 retrieves from classifier models storage 130 a classifier model that is configured to determine classifications for values of the attribute. Classifier model manager 115 then provides the value of the attribute as an input to the classifier model. The classifier model determines a classification for the value of the attribute based on the input. Classifier model manager 115 provides the determined classification to the requestor.

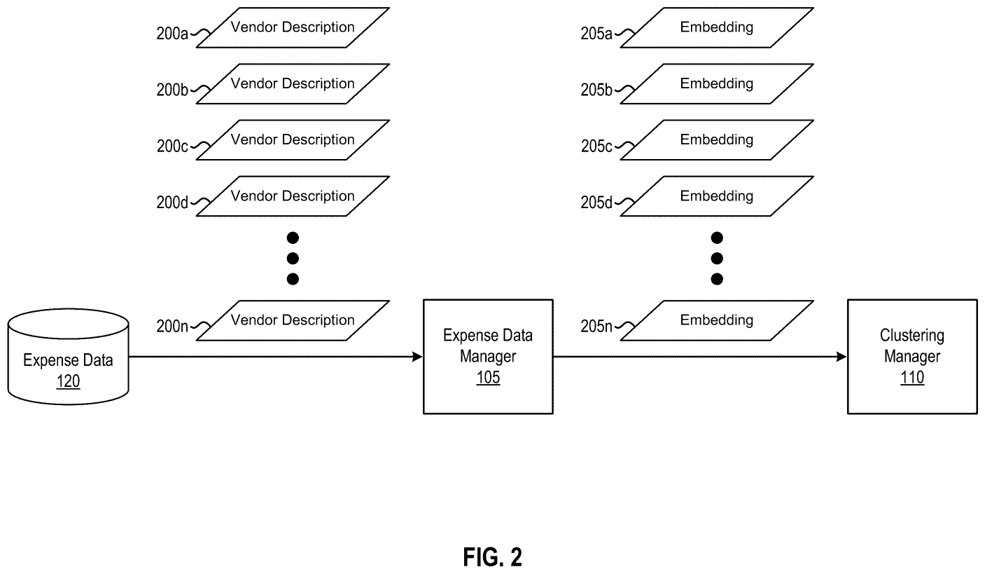

An example operation of computing system 100 will now be described by reference to FIGS. 2-6. The example operation will demonstrate how computing system 100 generates training data for a classifier model, trains the classifier model, and uses the classifier model. The operations begin by expense data manager 105 retrieving expense data from expense data storage 120 and processing it for clustering manager 110. FIG. 2 illustrates an example of retrieving expense data and generating embeddings according to some embodiments. As depicted in FIG. 2, expense data manager 105 retrieves expense data from expense data storage 120. For this example, expense data manager 105 retrieves from expense data storage 120 unique values 200a-n for a vendor description attribute in the expense data. Specifically, each of the unique values 200a-n is a string (e.g., a set of words, a phrase, a sentence, etc.). In some cases, expense data manager 105 retrieves attribute values 200a-n by querying expense data storage 120 for unique values of the vendor description attribute from line items included in expense reports. In some such cases, expense data manager 105 filters the query to line items with a transaction date that falls within a specified window of time (e.g., the most recent six months, the most recent year, the most recent two years, etc.).

Once expense data manager 105 retrieves attribute values 200a-n from expense data storage 120, expense data manager 105 generates a string embedding for each of the values 200a-n based on a string embedding space generated from a corpus of strings. The string embeddings are illustrated in FIG. 2 as embeddings 205a-n. As mentioned above, an embedding of a string is a vectorized representation of the string. As such, an embedding serves as a numeric representation of the string. When expense data manager 105 is finished generating embeddings 205a-n for values 200a-n, expense data manager 105s sends embeddings 205a-n to clustering manager 110 for further processing.

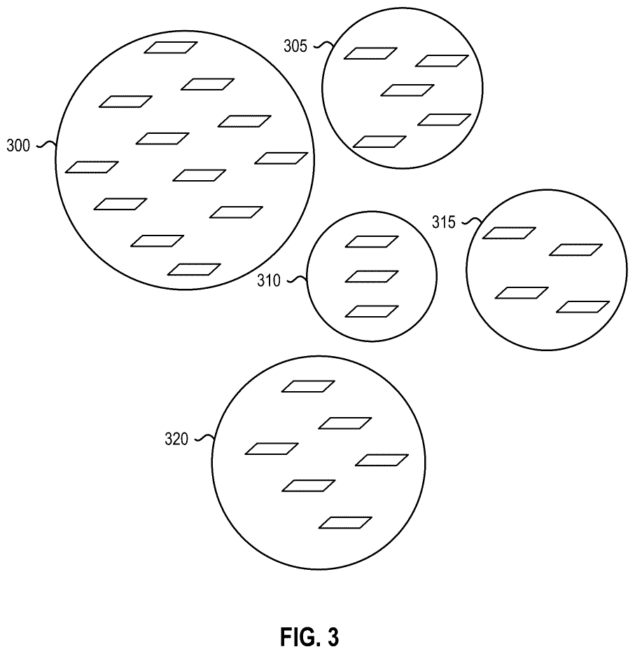

Upon receiving embeddings 205-an, clustering manager 110 groups embeddings 205-an into groups of embeddings. In this example, clustering manager 110 uses a k-means clustering algorithm to cluster embeddings 205a-n into a number of groups. In some embodiments, clustering manager 110 determines the number of groups into which to cluster embeddings 205a-n based on a silhouette analysis technique. In other embodiments, clustering manager 110 determines the number of groups into which to cluster embeddings 205a-n based on an elbow method. FIG. 3 illustrates an example of determining clusters 300-320 of embeddings 205a-n according to some embodiments. As shown in FIG. 3, each of the clusters 300-320 includes several of the embeddings 205. For this example, clustering manager 110 determines, based on a silhouette analysis technique, the number of groups into which embeddings 205a-n are to be clustered is five groups.

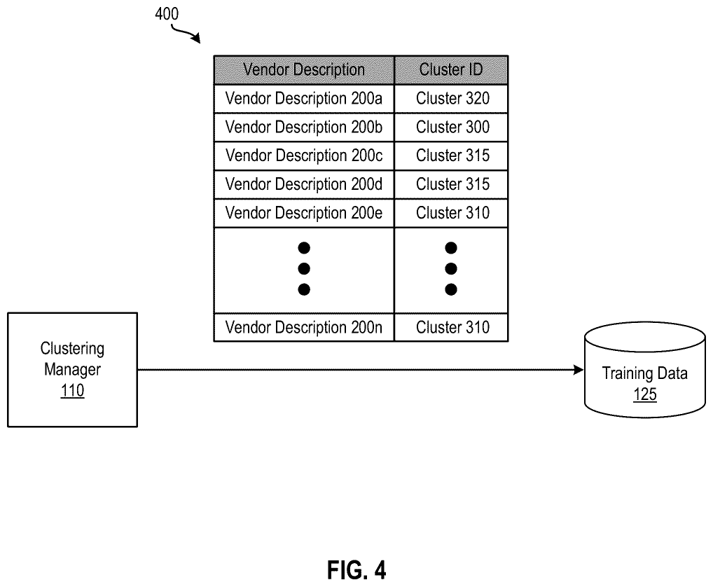

After clustering manager 110 finishes clustering embeddings 205a-n, clustering manager 110 assigns labels to the original string values of the vendor description attribute based on the groups of embeddings. Here, clustering manager 110 uses a cluster identifier (ID) as the value of the label. For each of the values 200a-n, clustering manager 110 determines the cluster ID to which the embedding of the value 200 belongs and assigns the cluster ID to the value 200. The labeled data forms a set of training data. FIG. 4 illustrates an example of labeling values 200a-n according to some embodiments. In particular, FIG. 4 illustrates a set of training data 400. As depicted, the set of training data 400 includes values 200a-n and their assigned labels (cluster IDs in this example). In this example, vendor description 200a was grouped into cluster 320, vendor description 200b was grouped into cluster 300, vendor descriptions 200c and 200d were grouped into cluster 315, and vendor descriptions 200e and 200n were grouped into cluster 310. Once clustering manager 110 completes the labeling of values 200a-n to form the set of training data 400, clustering manager 110 stores the set of training data 400 in training data storage 125.

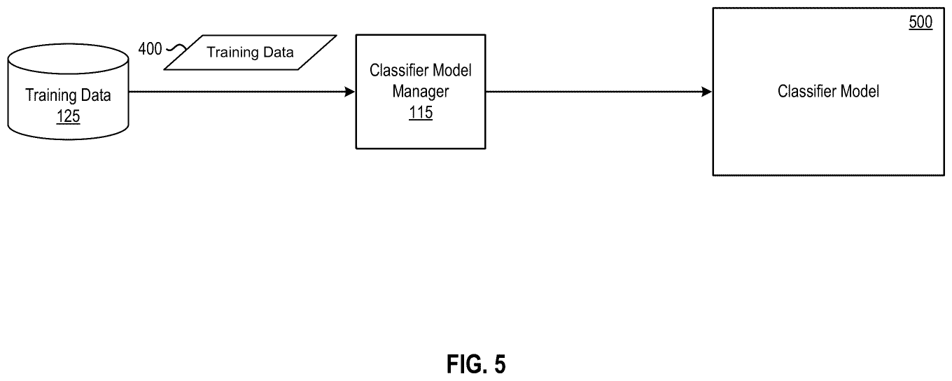

Continuing with the example, classifier model manager 115 trains a classifier model using the set of training data 400. FIG. 5 illustrates an example of training a classifier model 500 according to some embodiments. As illustrated, classifier model manager 115 accesses training data storage 125 to retrieve the set of training data 400. Here, classifier model manager 115 generates classifier model 500. In some instances, instead of generating classifier model 500, classifier model manager 115 may retrieve classifier model 500 from classifier models storage 130. Next, classifier model manager 115 uses the set of training data 400 to train classifier model 500 (e.g., by providing the set of training data as inputs to the classifier model, comparing the classifications predicted by the classifier model with the corresponding labels, adjusting the weights of the classifier model based on the comparisons, etc.). Classifier model manager 115 performs the appropriate operations to train classifier model 500 with the set of training data 400 based on the type of classifier of classifier model 500. Once classifier model 500 is trained, classifier model manager 115 stores it in classifier models storage 130.

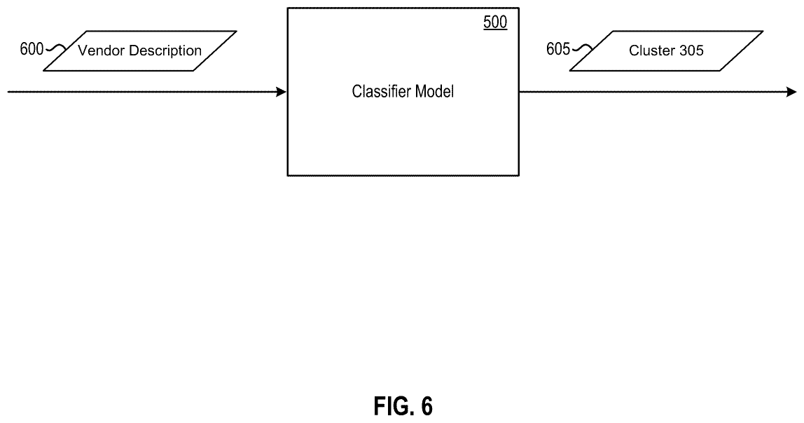

Now, trained classifier model 500 can be used for inference. FIG. 6 illustrates an example of using the classifier model 500 according to some embodiments. For this example, classifier model manager 115 receives a request (e.g., from computing system 100, an application or service operating on computing system 100, an application or service operating on another computing system, a client device interacting with computing system 100, etc.) to determine a classification for value 600 of the vendor description attribute. In response to the request, classifier model manager 115 retrieves classifier model 500 from classifier models storage 130. Then, classifier model manager 115 provides value 600 of the vendor description attribute as an input to classifier model 500, as shown in FIG. 6. Classifier model 500 determines a classification (e.g., a cluster ID in this example) for value 600 based on the input. As depicted, classifier model 500 determines classification 605 based on value 600. Classification 605 indicates that value 600 is classified as belonging to cluster 305. Classifier model manager 115 provides classification 605 to the requestor.

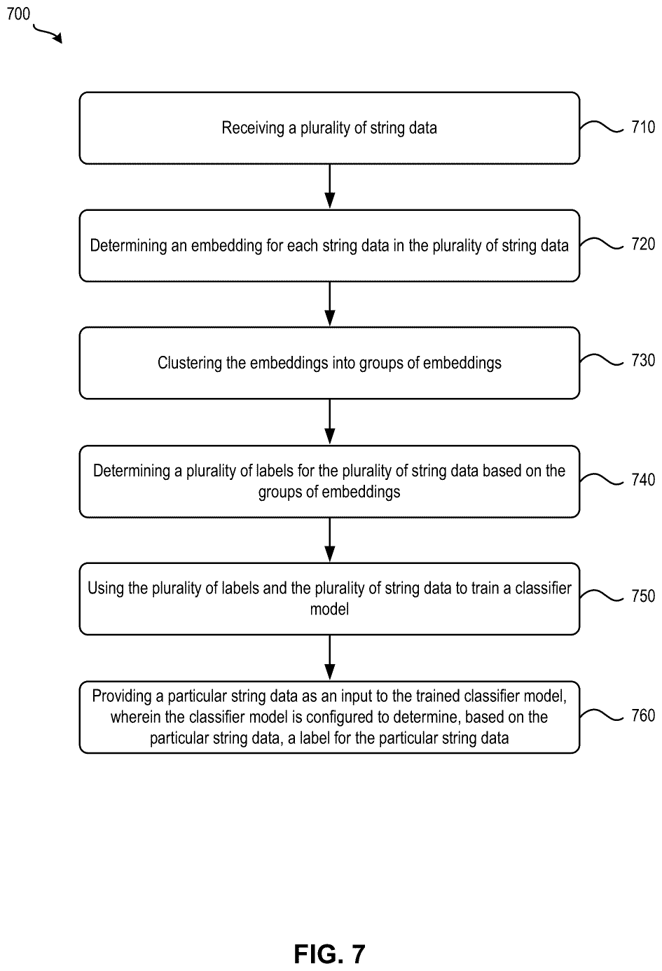

FIG. 7 illustrates a process 700 for classifying data attributes based on machine learning according to some embodiments. In some embodiments, computing system 100 performs process 700. Process 700 starts by receiving, at 710, a plurality of string data. Referring to FIG. 2 as an example, expense data manager 105 may receive values 200a-n for the vendor description attribute from expense data storage 120. Each of the values 200a-n is a string.

Next, process 700 determines, at 720, an embedding for each string data in the plurality of string data. Referring to FIG. 2 as an example, expense data manager 105 generates embeddings 205a-n for values 200a-n. Each embedding 205 is a vectorized representation of a corresponding value 200. Process 700 then clusters, at 730, the embeddings into groups of embeddings. Referring to FIGS. 1 and 3 as an example, clustering manager 110 groups embeddings 205a-n into clusters 300-320.

At 740, process 700 determines a plurality of labels for the plurality of string data based on the groups of embeddings. Referring to FIG. 4 as an example, clustering manager 110 uses the cluster IDs of clusters 300-320 as the label values for values 200a-n. For each of the values 200a-n, clustering manager 110 determines the cluster ID to which the embedding of the value 200 belongs and assigns the cluster ID to the value 200. The labeled values 200a-n form the set of training data 400.

Next, process 700 uses, at 750, the plurality of labels and the plurality of string data to train a classifier model. Referring to FIG. 5 as an example, classifier model manager 115 retrieves the set of training data 400 from training data storage 125 and uses it to train classifier model 500. Finally, process 700 provides, at 760, a particular string data as an input to the trained classifier model. The classifier model is configured to determine, based on the particular string data, a classification for the particular string data. Referring to FIG. 6 as an example, classifier model manager 115 provides value 600 of the vendor description attribute as an input to classifier model 500. Classifier model 500 is configured to determine, based on value 600, classification 605 for value 600.

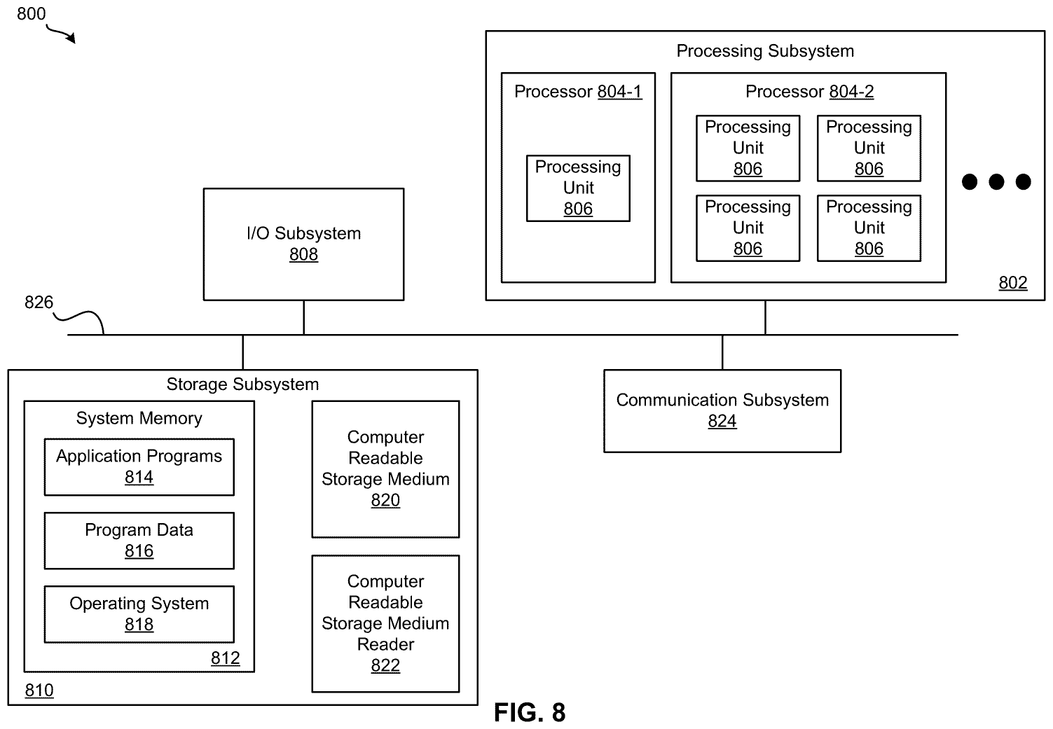

FIG. 8 illustrates an exemplary computer system 800 for implementing various embodiments described above. For example, computer system 800 may be used to implement computing system 100. Computer system 800 may be a desktop computer, a laptop, a server computer, or any other type of computer system or combination thereof. Some or all elements of expense data manager 105, clustering manager 110, classifier model manager 115, or combinations thereof can be included or implemented in computer system 800. In addition, computer system 800 can implement many of the operations, methods, and/or processes described above (e.g., process 700). As shown in FIG. 8, computer system 800 includes processing subsystem 802, which communicates, via bus subsystem 826, with input/output (I/O) subsystem 808, storage subsystem 810 and communication subsystem 824.

Bus subsystem 826 is configured to facilitate communication among the various components and subsystems of computer system 800. While bus subsystem 826 is illustrated in FIG. 8 as a single bus, one of ordinary skill in the art will understand that bus subsystem 826 may be implemented as multiple buses. Bus subsystem 826 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Extended ISA (EISA) bus, a Video Electronics Standards Association (VESA) local bus, a Peripheral Component Interconnect (PCI) bus, a Universal Serial Bus (USB), etc.

Processing subsystem 802, which can be implemented as one or more integrated circuits (e.g., a conventional microprocessor or microcontroller), controls the operation of computer system 800. Processing subsystem 802 may include one or more processors 804. Each processor 804 may include one processing unit 806 (e.g., a single core processor such as processor 804-1) or several processing units 806 (e.g., a multicore processor such as processor 804-2). In some embodiments, processors 804 of processing subsystem 802 may be implemented as independent processors while, in other embodiments, processors 804 of processing subsystem 802 may be implemented as multiple processors integrate into a single chip or multiple chips. Still, in some embodiments, processors 804 of processing subsystem 802 may be implemented as a combination of independent processors and multiple processors integrated into a single chip or multiple chips.

In some embodiments, processing subsystem 802 can execute a variety of programs or processes in response to program code and can maintain multiple concurrently executing programs or processes. At any given time, some or all of the program code to be executed can reside in processing subsystem 802 and/or in storage subsystem 810. Through suitable programming, processing subsystem 802 can provide various functionalities, such as the functionalities described above by reference to process 700, etc.

I/O subsystem 808 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 800 to a user or another device (e.g., a printer).

As illustrated in FIG. 8, storage subsystem 810 includes system memory 812, computer-readable storage medium 820, and computer-readable storage medium reader 822. System memory 812 may be configured to store software in the form of program instructions that are loadable and executable by processing subsystem 802 as well as data generated during the execution of program instructions. In some embodiments, system memory 812 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 812 may include different types of memory, such as static random access memory (SRAM) and/or dynamic random access memory (DRAM). System memory 812 may include a basic input/output system (BIOS), in some embodiments, that is configured to store basic routines to facilitate transferring information between elements within computer system 800 (e.g., during start-up). Such a BIOS may be stored in ROM (e.g., a ROM chip), flash memory, or any other type of memory that may be configured to store the BIOS.

As shown in FIG. 8, system memory 812 includes application programs 814, program data 816, and operating system (OS) 818. OS 818 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Computer-readable storage medium 820 may be a non-transitory computer-readable medium configured to store software (e.g., programs, code modules, data constructs, instructions, etc.). Many of the components (e.g., expense data manager 105, clustering manager 110, and classifier model manager 115) and/or processes (e.g., process 700) described above may be implemented as software that when executed by a processor or processing unit (e.g., a processor or processing unit of processing subsystem 802) performs the operations of such components and/or processes. Storage subsystem 810 may also store data used for, or generated during, the execution of the software.

Storage subsystem 810 may also include computer-readable storage medium reader 822 that is configured to communicate with computer-readable storage medium 820. Together and, optionally, in combination with system memory 812, computer-readable storage medium 820 may comprehensively represent remote, local, fixed, and/or removable storage devices plus storage media for temporarily and/or more permanently containing, storing, transmitting, and retrieving computer-readable information.

Computer-readable storage medium 820 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSDs), flash memory card (e.g., secure digital (SD) cards, CompactFlash cards, etc.), USB flash drives, or any other type of computer-readable storage media or device.

Communication subsystem 824 serves as an interface for receiving data from, and transmitting data to, other devices, computer systems, and networks. For example, communication subsystem 824 may allow computer system 800 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 824 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 824 may provide components configured for wired communication (e.g., Ethernet) in addition to or instead of components configured for wireless communication.

One of ordinary skill in the art will realize that the architecture shown in FIG. 8 is only an example architecture of computer system 800, and that computer system 800 may have additional or fewer components than shown, or a different configuration of components. The various components shown in FIG. 8 may be implemented in hardware, software, firmware or any combination thereof, including one or more signal processing and/or application specific integrated circuits.

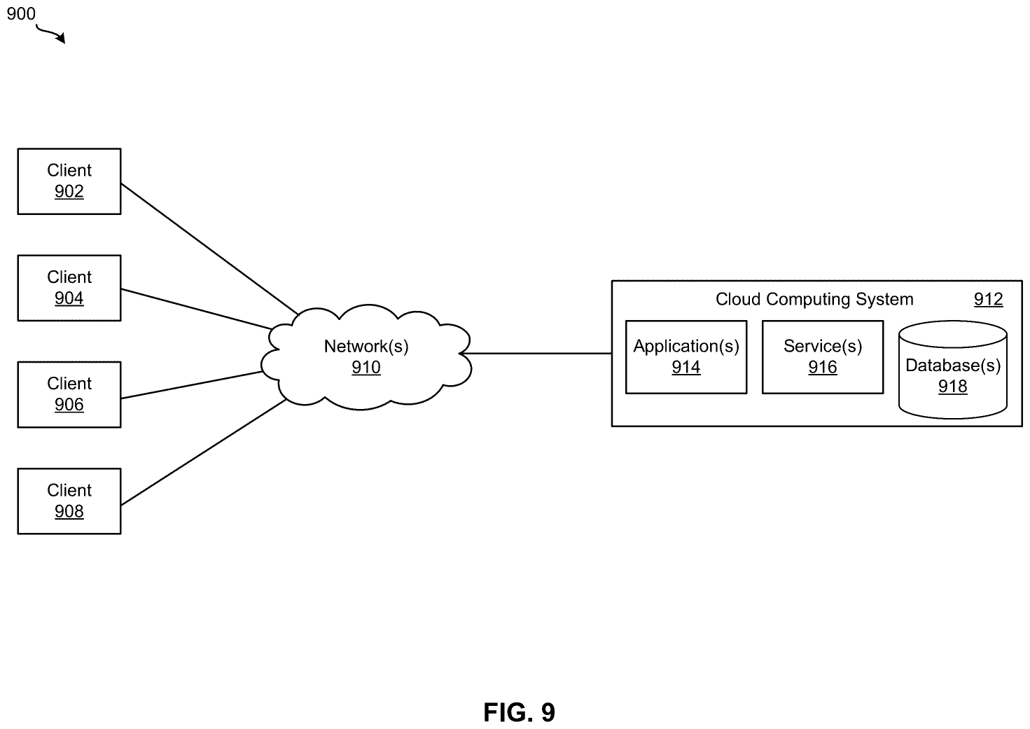

FIG. 9 illustrates an exemplary system 900 for implementing various embodiments described above. For example, cloud computing system 920 may be used to implement computing system 100. As shown, system 900 includes client devices 902-908, one or more networks 910, and cloud computing system 912. Cloud computing system 912 is configured to provide resources and data to client devices 902-908 via networks 910. In some embodiments, cloud computing system 912 provides resources to any number of different users (e.g., customers, tenants, organizations, etc.). Cloud computing system 912 may be implemented by one or more computer systems (e.g., servers), virtual machines operating on a computer system, or a combination thereof.

As shown, cloud computing system 912 includes one or more applications 914, one or more services 916, and one or more databases 918. Cloud computing system 912 may provide applications 914, services 916, and databases 918 to any number of different customers in a self-service, subscription-based, elastically scalable, reliable, highly available, and secure manner.

In some embodiments, cloud computing system 912 may be adapted to automatically provision, manage, and track a customer's subscriptions to services offered by cloud computing system 912. Cloud computing system 912 may provide cloud services via different deployment models. For example, cloud services may be provided under a public cloud model in which cloud computing system 912 is owned by an organization selling cloud services and the cloud services are made available to the general public or different industry enterprises. As another example, cloud services may be provided under a private cloud model in which cloud computing system 912 is operated solely for a single organization and may provide cloud services for one or more entities within the organization. The cloud services may also be provided under a community cloud model in which cloud computing system 912 and the cloud services provided by cloud computing system 912 are shared by several organizations in a related community. The cloud services may also be provided under a hybrid cloud model, which is a combination of two or more of the aforementioned different models.

In some instances, any one of applications 914, services 916, and databases 918 made available to client devices 902-908 via networks 910 from cloud computing system 912 is referred to as a “cloud service.” Typically, servers and systems that make up cloud computing system 912 are different from the on-premises servers and systems of a customer. For example, cloud computing system 912 may host an application and a user of one of client devices 902-908 may order and use the application via networks 910.

Applications 914 may include software applications that are configured to execute on cloud computing system 912 (e.g., a computer system or a virtual machine operating on a computer system) and be accessed, controlled, managed, etc. via client devices 902-908. In some embodiments, applications 914 may include server applications and/or mid-tier applications (e.g., HTTP (hypertext transfer protocol) server applications, FTP (file transfer protocol) server applications, CGI (common gateway interface) server applications, JAVA server applications, etc.). Services 916 are software components, modules, application, etc. that are configured to execute on cloud computing system 912 and provide functionalities to client devices 902-908 via networks 910. Services 916 may be web-based services or on-demand cloud services.

Databases 918 are configured to store and/or manage data that is accessed by applications 914, services 916, and/or client devices 902-908. For instance, storages 130-140 may be stored in databases 918. Databases 918 may reside on a non-transitory storage medium local to (and/or resident in) cloud computing system 912, in a storage-area network (SAN), on a non-transitory storage medium local located remotely from cloud computing system 912. In some embodiments, databases 918 may include relational databases that are managed by a relational database management system (RDBMS). Databases 918 may be a column-oriented databases, row-oriented databases, or a combination thereof. In some embodiments, some or all of databases 918 are in-memory databases. That is, in some such embodiments, data for databases 918 are stored and managed in memory (e.g., random access memory (RAM)).

Client devices 902-908 are configured to execute and operate a client application (e.g., a web browser, a proprietary client application, etc.) that communicates with applications 914, services 916, and/or databases 918 via networks 910. This way, client devices 902-908 may access the various functionalities provided by applications 914, services 916, and databases 918 while applications 914, services 916, and databases 918 are operating (e.g., hosted) on cloud computing system 912. Client devices 902-908 may be computer system 800, as described above by reference to FIG. 8. Although system 900 is shown with four client devices, any number of client devices may be supported.

Networks 910 may be any type of network configured to facilitate data communications among client devices 902-908 and cloud computing system 912 using any of a variety of network protocols. Networks 910 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present disclosure along with examples of how aspects of the present disclosure may be implemented. The above examples and embodiments should not be deemed to be the only embodiments, and are presented to illustrate the flexibility and advantages of various embodiments of the present disclosure as defined by the following claims. Based on the above disclosure and the following claims, other arrangements, embodiments, implementations and equivalents will be evident to those skilled in the art and may be employed without departing from the spirit and scope of the present disclosure as defined by the claims.

What is claimed is:

1. A non-transitory machine-readable medium storing a program executable by at least one processing unit of a device, the program comprising sets of instructions for:
receiving a plurality of string data;
determining an embedding for each string data in the plurality of string data;
clustering the embeddings into groups of embeddings;
determining a plurality of labels for the plurality of string data based on the groups of embeddings;
using the plurality of labels and the plurality of string data to train a classifier model; and
providing a particular string data as an input to the trained classifier model, wherein the classifier model is configured to determine, based on the particular string data, a classification for the particular string data.

2. The non-transitory machine-readable medium of claim 1, wherein the embedding for each string data in the plurality of string data is a vectorized representation of the string data.

3. The non-transitory machine-readable medium of claim 1, wherein clustering the embeddings into the groups of embeddings comprises using a k-means clustering algorithm to cluster the embeddings into the group of embeddings.

4. The non-transitory machine-readable medium of claim 1, wherein the program further comprises a set of instructions for determining a number of the groups of embeddings into which the embeddings are clustered.

5. The non-transitory machine-readable medium of claim 4, wherein determining the number of the groups of embeddings comprises determining the number of the groups of embeddings based on a silhouette analysis technique.

6. The non-transitory machine-readable medium of claim 4, wherein determining the number of the groups of embeddings comprises determining the number of the groups of embeddings based on an elbow method.

7. The non-transitory machine-readable medium of claim 1, wherein the plurality of labels comprises a plurality of cluster identifiers, each cluster identifier in the plurality of cluster identifiers for identifying a group of embeddings in the groups of embeddings.

8. A method comprising:
receiving a plurality of string data;
determining an embedding for each string data in the plurality of string data;
clustering the embeddings into groups of embeddings;
determining a plurality of labels for the plurality of string data based on the groups of embeddings;
using the plurality of labels and the plurality of string data to train a classifier model; and
providing a particular string data as an input to the trained classifier model, wherein the classifier model is configured to determine, based on the particular string data, a classification for the particular string data.

9. The method of claim 8, wherein the embedding for each string data in the plurality of string data is a vectorized representation of the string data.

10. The method of claim 8, wherein clustering the embeddings into the groups of embeddings comprises using a k-means clustering algorithm to cluster the embeddings into the group of embeddings.

11. The method of claim 8 further comprising determining a number of the groups of embeddings into which the embeddings are clustered.

12. The method of claim 11, wherein determining the number of the groups of embeddings comprises determining the number of the groups of embeddings based on a silhouette analysis technique.

13. The method of claim 11, wherein determining the number of the groups of embeddings comprises determining the number of the groups of embeddings based on an elbow method.

14. The method of claim 8, wherein the plurality of labels comprises a plurality of cluster identifiers, each cluster identifier in the plurality of cluster identifiers for identifying a group of embeddings in the groups of embeddings.

15. A system comprising:
a set of processing units; and
a non-transitory machine-readable medium storing instructions that when executed by at least one processing unit in the set of processing units cause the at least one processing unit to:
receive a plurality of string data;
determine an embedding for each string data in the plurality of string data;
cluster the embeddings into groups of embeddings;
determine a plurality of labels for the plurality of string data based on the groups of embeddings;
use the plurality of labels and the plurality of string data to train a classifier model; and
provide a particular string data as an input to the trained classifier model, wherein the classifier model is configured to determine, based on the particular string data, a classification for the particular string data.

16. The system of claim 15, wherein the embedding for each string data in the plurality of string data is a vectorized representation of the string data.

17. The system of claim 15, wherein clustering the embeddings into the groups of embeddings comprises using a k-means clustering algorithm to cluster the embeddings into the group of embeddings.

18. The system of claim 15, wherein the instructions further cause the at least one processing unit to determine a number of the groups of embeddings into which the embeddings are clustered.

19. The system of claim 18, wherein determining the number of the groups of embeddings comprises determining the number of the groups of embeddings based on a silhouette analysis technique.

20. The system of claim 18, wherein determining the number of the groups of embeddings comprises determining the number of the groups of embeddings based on an elbow method.
